(19) United States
(12) Patent Application Publication
(10) Pub. No.: US 2025/0348629 A1
(43) Pub. Date: Nov. 13, 2025

(54) Scoring and Ranking of Geometric Tolerances

(71) Applicant: Howmedica Osteonics Corp., Mahwah, NJ (US)

(72) Inventor: Shea Morrissey, Limerick (IE)

(21) Appl. No.: 18/706,774

(22) PCT Filed: Nov. 2, 2022
(86) PCT No.: PCT/US2022/048692

§ 371 Date: May 2, 2024

Related U.S. Application Data
(60) Provisional application No. 63/275,140, filed on Nov. 3, 2021.

(51) Int. Cl. G06F 30/17; G06F 30/12; G06F 111/04

(52) U.S. Cl. CPC G06F 30/17; G06F 30/12; G06F 2111/04

(57) ABSTRACT

A computer implemented method of designing an object in a Computer Aided Design (“CAD”) application using Geometric Dimensioning and Tolerancing (GD&T), includes drawing, by one or more processors, an object in the CAD application; applying, by one or more processors, a geometric tolerance to at least one of the features (502) having one or more of Form, Orientation, and Location constraints and a tolerance range according to a GD&T standard; determining, by the one or more processors, a relative cost of the geometric tolerance (508) using the tolerance range and a total number of the one or more constraints of Form, Orientation, and Location; and automatically generating a notification to the user (512) of a relative cost of the geometric tolerance relative to narrower and/or broader tolerance ranges than the tolerance range selected for the one or more features of the object.

### CROSS-REFERENCE TO RELATED APPLICATIONS

This application claims the benefit of the filing date of U.S. Provisional Application No. 63/275,140, filed Nov. 3, 2021, the disclosure of which is hereby incorporated by reference herein.

### BACKGROUND OF THE INVENTION

All manufactured objects have designed tolerances to ensure that they function as intended despite the reality of manufacturing imperfections. However, it has been long known that tolerances are a significant driver of business costs as tighter tolerances are more expensive to manufacture. These higher costs stem from a variety of factors which include additional operations after primary machining, the need for precision tools and equipment and their associated higher acquisition and maintenance costs, the need for higher skilled labor, longer operating cycles, more costly materials, and higher scrap and rework costs.

Despite these excessive costs, there has been an upward trend in the design of new products to apply tighter tolerances in the absence of a systematic way to evaluate whether the applied tolerances are too tight and therefore unnecessarily costly and challenging to manufacture. Evaluation is usually dependent on the experience of the reviewer and a subjective assessment of small versus large numerical values for a selected dimension. In this regard, specialists may be called upon well into the design process to review a design. However, this is not always the case and even then, results may vary. Thus, the individual designer or design group is often at a distance and without tools to evaluate the consequences of a tolerance early in the design process and consequently the ability to take remedial actions when most appropriate and efficient. Therefore, further improvements are desirable.

### BRIEF SUMMARY OF THE INVENTION

In one aspect of the present disclosure, a computer-implemented method of scoring and ranking a geometric tolerance applied to an object feature having one or more dimensions in a Computer Aided Design (“CAD”) application by a user in accordance with Geometric Dimensioning and Tolerancing (“GD&T”) standard is described. The geometric tolerance has one or more of Form, Orientation, and Location constraints and a tolerance range. The method includes determining, by one or more processors executing a CAD application, a sources of variation (SoV) score based on a total number of Form, Orientation, and Location constraints of the geometric tolerance, the SoV score is calculated in the background of the CAD application; determining, the one or more processors, a tolerance rank based on the SoV score, the tolerance range, and one of the one or more dimensions of the object feature via a database correlating the SoV score, tolerance range, and the one of the one or more dimensions, the tolerance rank having an identifier that indicates its position in a tolerance band relative to other tolerance ranks in the tolerance band; and automatically generating a notification for presentation to the user of the tolerance rank.

Additionally, the step of determining the SoV score may include determining whether the object feature is one-dimensional, two-dimensional, or three-dimensional. The method may further comprise automatically generating a prompt requesting the user to verify the determination of whether the object feature is one-dimensional, two-dimensional, or three-dimensional. Also, the geometric tolerance may include one or more datum and a step of determining the SoV score may include correlating the Form, Orientation, and Location constraints to the one or more datum and counting the number of instances of Form, Orientation, and Location for each of the one or more datum. The geometric tolerance may include a geometric character symbol and correlating the Form, Orientation, and Location constraints to the one or more datum may be performed by reference to a GD&T Rules table that correlates the geometric characteristic symbol with the number of Form, Orientation, and Location constraints and a given datum.

Continuing with this aspect, determining the SoV score may include determining whether the one or more datum is affected by interdependence. When datum is affected by interdependence, a lead and following dimension are assigned, and larger tolerances are applied to the follow dimension than the lead dimensions. The geometric tolerance may include a multitude which is the total number of object features to which the geometric tolerance has been applied, and determining the SoV score may include summing the multitude with the total number of Form, Orientation, and Location constraints. The method may further comprise determining a relative cost of the geometric tolerance based on the tolerance rank. Also, the automatically notifying step includes notifying the user of the relative cost. The determining steps and alerting steps may be performed by a Scoring and Ranking plugin in communication with the CAD application. Further, the determining and alerting steps may be performed automatically by the Scoring and Ranking plugin once the geometric tolerance is applied to the object feature. Even further, the automatically notifying step may be performed when the tolerance rank falls within a category of concern. If the tolerance rank falls within a category of concern, the method may further include at least one of decreasing the total number of Form, Orientation, and Location constraints and expanding the tolerance range, and repeating the determining steps.

### BRIEF DESCRIPTION OF THE DRAWINGS

The features, aspects, and advantages of the present invention will become better understood with regard to the following description, appended claims, and accompanying drawings in which:

FIG. 1 is an exemplary system that may be used in accordance with aspects of the disclosure.

FIG. 2 is a diagram of various devices that may be used in connection with the example system.

FIG. 3 is a schematic of a CAD application and Scoring and Ranking Plugin of the exemplary system of FIG. 1 according to an embodiment of the present disclosure.

FIG. 4 is a schematic of a CAD application and Scoring and Ranking Plugin of the exemplary system of FIG. 1 according to another embodiment of the present disclosure.

FIG. 5 is a schematic of components of the Scoring and Ranking Plugin or Module of FIGS. 3 and 4.

FIG. 6 is a flow diagram describing an example of a method that may be used to implement aspects of the disclosure.

FIG. 7 is an exemplary feature control frame in accordance with Geometric Dimensioning and Tolerancing standards.

FIG. 8 is a diagram of theoretical tiles in datum reference frame demonstrating degrees of freedom and geometric tolerances with higher levels of constraint.

FIG. 9 is a table of Geometric Dimensioning and Tolerancing character symbols.

FIG. 10 is an exemplary Geometric Dimensioning and Tolerancing rules table of the Scoring and Ranking Plugin or Module of FIGS. 3 and 4.

FIG. 11 is an example application of various steps of the method of FIG. 6.

FIG. 12 is perspective view of an assembly having geometric tolerances applied thereto.

FIG. 13A is a side view of a femoral component of a total knee prosthesis having geometric tolerances applied thereto.

FIG. 13B is a decision tree logic for interdependence.

FIG. 13C is an exemplary dimension interdependency matrix.

FIG. 14A is a Relative Cost 3-D Array of the Scoring and Ranking Plugin or Module of FIGS. 3 and 4.

FIG. 14B is a Relative Cost Scale of the Relative Cost 3-D Array of FIG. 14A correlated with various production methods.

FIG. 15 another example application of various steps of the method of FIG. 6.

FIG. 16 is a further example application of various steps of the method of FIG. 6.

FIG. 17 is a chart of comparison of high and low capability processes.

FIG. 18 is a chart summing complexity and relative costs of parts, assemblies, and products within a factory/business.

FIG. 19 is a chart of measures of complexity and costs.

FIG. 20A is a chart of internal views of value and complexity.

FIG. 20B is a chart of external views of value and complexity.

FIG. 20C is a chart of value and complexity for example products.

FIG. 20D is a table of costs, quality, price, and profitability for the example products of FIG. 20C.

### DETAILED DESCRIPTION

As used herein, the term “object” is intended to mean any device, part, component, assembly, and the like, that is subject to being manufactured via any know or unknown manufacturing process. Also, the term “feature” or “object feature” is intended to mean a feature of an object, such as a surface, hole, or dimension, that is capable of having a geometric tolerance applied to it.

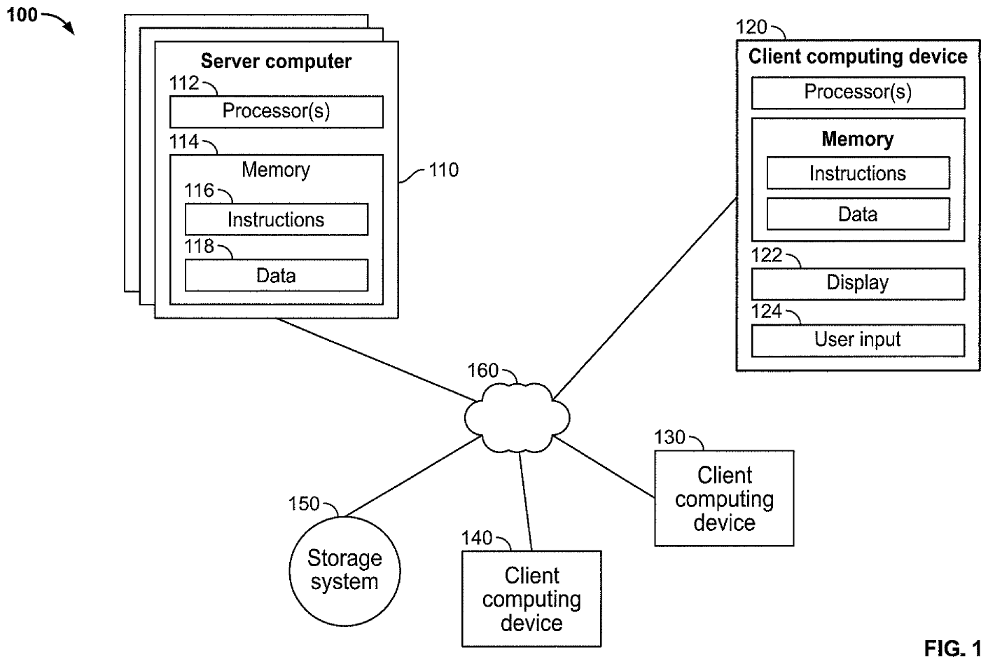

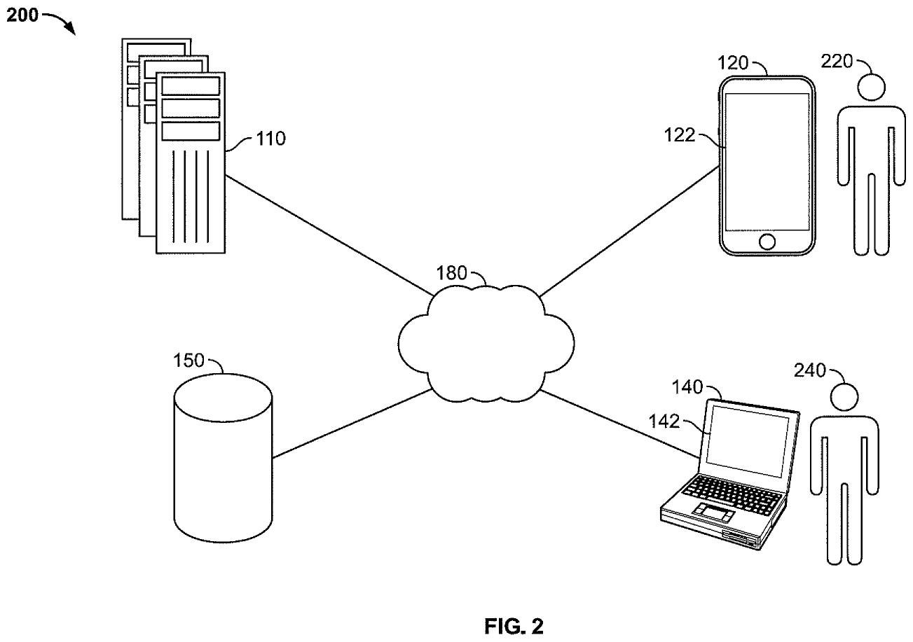

FIGS. 1 and 2 depict an exemplary system 100 for scoring and ranking geometric tolerances applied to the design of an object intended for manufacturing. As an exemplary system, it should not be considered as limiting the scope of the disclosure or usefulness of the features described herein. As shown, system 100 can include computing devices 110, 120, 130, and 140 as well as storage system 150. Each of computing devices 110, 120, 130, and 140 can contain one or more processors 112, memory 114 and other components typically present in general purpose computing devices. Memory 114 of each of computing devices 110, 120, 130, and 140 can store information accessible by the one or more processors 112, including instructions 116 that can be executed by the one or more processors 112.

Memory can also include data 118 that can be retrieved, manipulated or stored by the processor. The memory can be of any non-transitory type capable of storing information accessible by the processor, such as a hard-drive, memory card, ROM, RAM, DVD, CD-ROM, write-capable, and read-only memories.

The instructions 116 can be any set of instructions to be executed directly, such as machine code, or indirectly, such as scripts, by the one or more processors. In that regard, the terms “instructions,” “application,” “steps,” and “programs” can be used interchangeably herein. The instructions can be stored in object code format for direct processing by a processor, or in any other computing device language including scripts or collections of independent source code modules that are interpreted on demand or compiled in advance. Functions, methods, and routines of the instructions are explained in more detail below.

Data 118 may be retrieved, stored or modified by the one or more processors 112 in accordance with the instructions 116. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The one or more processors 112 can be any conventional processors, such as a commercially available CPU. Alternatively, the processors can be dedicated components such as an application specific integrated circuit (“ASIC”) or other hardware-based processor.

Although FIG. 1 functionally illustrates the processor, memory, and other elements of computing devices 110, 120, 130, and 140 as being within the same block, the processor, computer, computing device, or memory can comprise multiple processors, computers, computing devices, or memories that may or may not be stored within the same physical housing. For example, the memory can be a hard drive or other storage media located in housings different from that of the computing devices 110, 120, 130, and 140. Accordingly, references to a processor, computer, computing device, or memory will be understood to include references to a collection of processors, computers, computing devices, or memories that may or may not operate in parallel. For example, the computing device 110 may include server computing devices operating as a load-balanced server farm, distributed system, etc. Yet further, although some functions described below are indicated as taking place on a single computing device having a single processor, various aspects of the subject matter described herein can be implemented by a plurality of computing devices, for example, communicating information over network 160.

The one or more computing devices 110, 120, 130, and 140 can be at different nodes of a network 160 and capable of directly and indirectly communicating with other nodes of network 160. Although only a few computing devices are depicted in FIGS. 1 and 2, it should be appreciated that a typical system can include many connected computing devices, with each different computing device being at a different node of the network 160. The network 160 and intervening nodes described herein can be interconnected using various protocols and systems, such that the network can be part of the Internet, World Wide Web, specific intranets, wide area networks, or local networks. The network can utilize standard communications protocols, such as Ethernet, WiFi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, each of the computing devices 110, 120, 130, and 140 may include web servers capable of communicating with storage system 150 as well as the other computing devices via network 160. For example, one or more of server computing devices 110 may use network 160 to transmit and present information to a user, such as user 220, 230, or 240, on a display, such as displays 122, 132, or 142 of computing devices 120, 130, or 140. In this regard, computing devices 120, 130, and 140 may be considered client computing devices and may perform all or some of the features described herein.

Each of the client computing devices 120, 130, and 140 may be configured similarly to the server computing devices 110, with one or more processors, memory and instructions as described above. Each client computing device 120, 130, or 140 may be a personal computing device intended for use by a user 220, 230, 240, and have all of the components normally used in connection with a personal computing device such as a central processing unit (CPU), memory (e.g., RAM and internal hard drives) storing data and instructions, a display such as displays 122, 132, or 142 (e.g., a monitor having a screen, a touch-screen, a projector, a television, or other device that is operable to display information), and user input device 124 (e.g., a mouse, keyboard, or touch screen).

Although the client computing devices 120, 130, and 140 may each comprise a full-sized personal computing device, they may alternatively comprise mobile computing devices capable of wirelessly exchanging data with a server over a network such as the Internet. By way of example only, client computing device 120 may be a mobile phone or a device such as a wireless-enabled PDA, a tablet PC, or a netbook that is capable of obtaining information via the Internet.

As with memory 114, storage system 150 can be of any type of computerized storage capable of storing information accessible by the server computing devices 110, such as a hard-drive, memory card, ROM, RAM, DVD, CD-ROM, write-capable, and read-only memories. In addition, storage system 150 may include a distributed storage system where data is stored on a plurality of different storage devices which may be physically located at the same or different geographic locations. Storage system 150 may be connected to computing devices 110, 120, 130, and 140 via network 160 as shown in FIG. 1 and/or may be directly connected thereto (not shown).

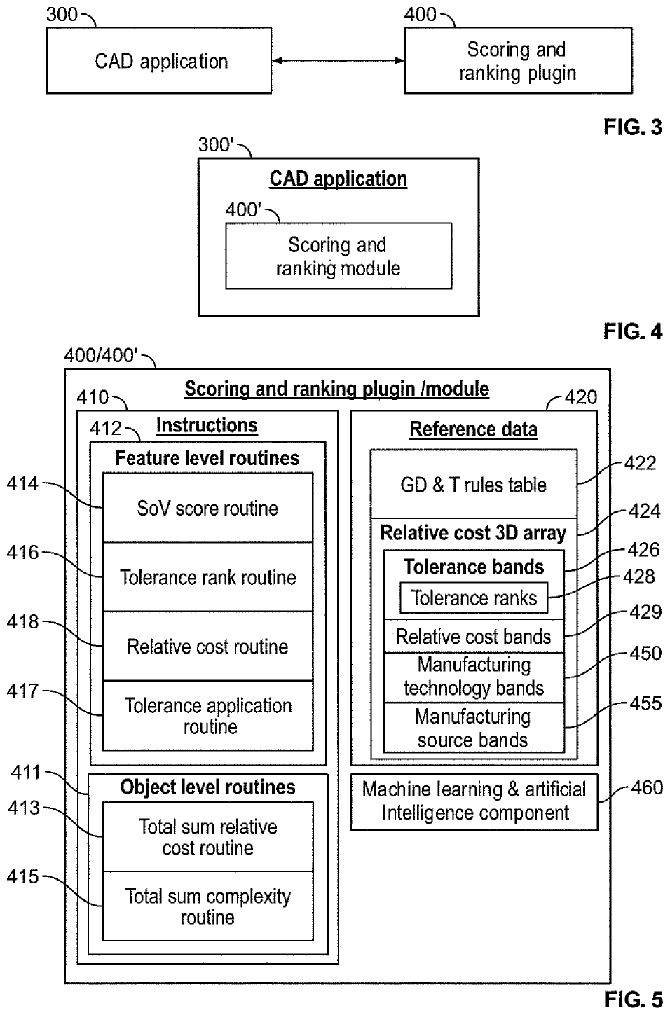

FIG. 3 depicts the general components that can be used in system 100 and that are configured to implement the methods of scoring and ranking geometric dimensions described below. The first component is an existing Computer Aided Design (CAD) application 300, such as Solidworks of Dassault Systèmes Se (Vélizy-Villcoublay France) and AutoCad of Autodesk (San Rafael, CA), for example. The second component is a Scoring and Ranking plugin 400 that can communicate back and forth with CAD application 300 via an interface, such as a plugin API, for example.

FIG. 4 depicts an alternative configuration in which a CAD application 300′ is modified or built from scratch to include an integrated Scoring and Ranking module 400′. However, in either embodiment, the Scoring and Ranking plugin or module 400/400′ is configured to operate autonomously in the background of the CAD application 300/300′ to perform the methods described herein while a user uses the CAD application 300/300′ to design an object and its features. In other words, the Scoring and Ranking plugin or module 400/400′ operates in real-time without user input, manipulation, or operations while the user performs or can perform other functions in the CAD application 300/300′.

FIG. 5 depicts the components of the Scoring and Ranking plugin or module 400/400′, which includes instructions 410 and reference data 420. The instructions 410 include feature level routines 412 and object level routines 411. The feature level routines 412 generally correspond to geometric tolerances applied to individual features or dimensions of an object being designed in the CAD application. In this regard, Source of Variation (“SoV”) Routine 414, Tolerance Rank Routine 416, and Relative Cost Routine 418 respectively determine an SoV score, tolerance rank, and relative cost for a designated feature or dimension of the object. In contrast, the object level routines 411 generally apply to the object as a whole. In this regard, a Total Sum Relative Cost Routine 413 and Total Sum Complexity Routine 415 respectively determine a relative cost and complexity of the sum of its features based on the aggregation of the data determined and collected from the feature level routines 412.

Reference data 420 may be referred to during the implementation of the aforementioned routines. Such reference data 420 generally includes a Geometric Dimensioning and Tolerancing (“GD&T”) Table 422 and a Relative Cost 3D Array 424 which is comprised of linear tolerance bands 426 of tolerance ranks 428, as explained in more detail below.

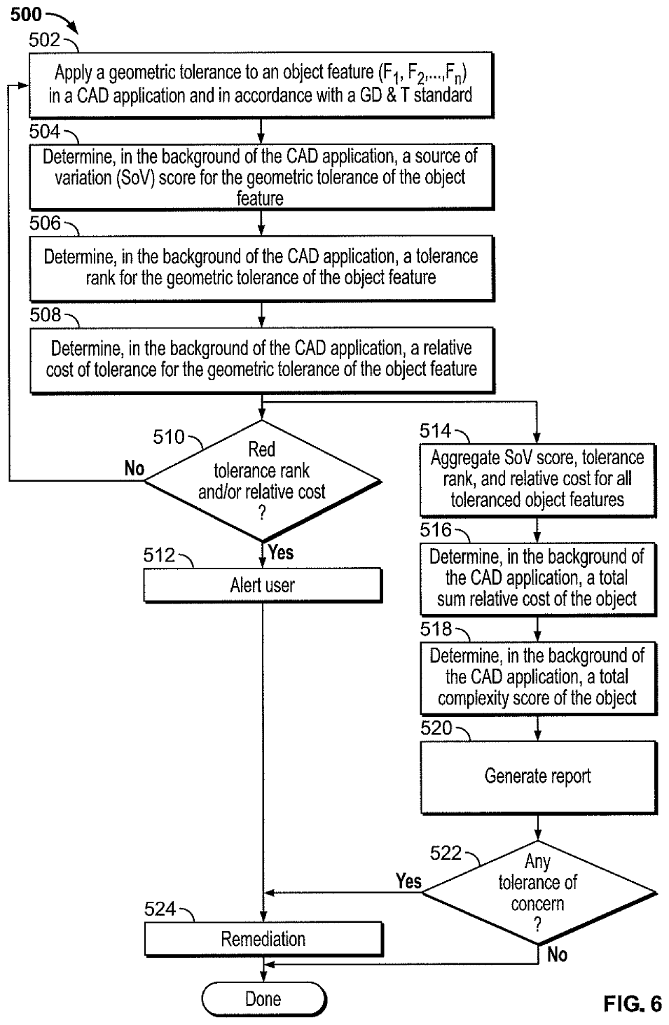

Flow diagram 500 of FIG. 6 is an example method that may be performed by one or more computing devices, such as computing devices 110, 120, 130, and 140, described above.

As shown in block 502 of this example method, a user applies a geometric tolerance to an object feature in CAD application 300/300′ and in accordance with a GD&T standard. This includes applying a GD&T feature control frame, identifying datum (if any), and applying basic dimensions to the feature and/or from the feature to the datum.

GD&T is a system and symbolic language for communicating the design intent of an object between relevant parties to ensure the manufactured object has the desired form, fit, function, and interchangeability. The specification, interpretation, and evaluation of geometric tolerances are set forth by the American Society of Mechanical Engineers (ASME) Codes and Standards 2018 (ASME Y14.5) and the International Organization for Standardization 2017 (ISO 2017 GPS). These codified standards establish a uniform GD&T language that is applied to engineering drawings, digital models, and the like to provide a high level of specification above simple lengths and circular diameters.

In manufacturing, deviations are inevitably observed on every manufactured object due to the fundamental axioms of manufacturing imprecision and measurement uncertainty. GD&T recognizes that object features typically have size and geometry which exist in space in multiple dimensions. The symbolic language of GD&T allows a user to establish a tolerance zone (i.e., geometric tolerance) within which the object feature, including its deviations, must reside. In this regard, a tolerance zone is typically established in space relative to one or more user defined datums so that the tolerance zone conforms to the geometry of the selected feature. This gives the designer a greater level of control in specification, and the manufacturer and quality control inspector a greater level of control over a feature's geometry and deviations in manufacturing.

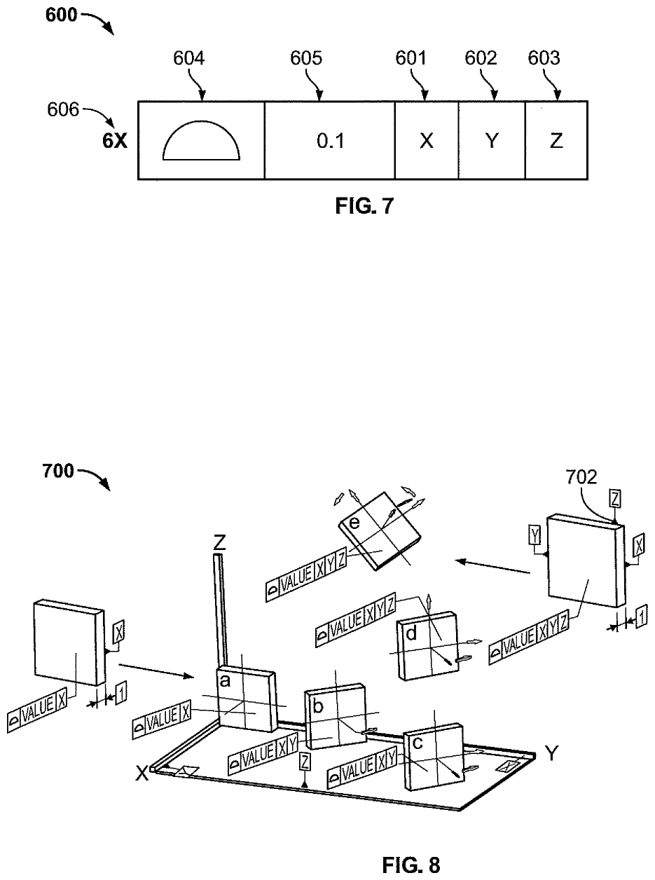

GD&T instructions are typically set forth on an engineering drawing or digital model via a feature control frame. An exemplary feature control frame 600 is shown in FIG. 7. This exemplary control frame 600 includes a geometric character symbol 604, tolerance or tolerance range 605, primary datum 601, secondary datum 602, and tertiary datum 603. Other modifying symbols can be used but are not shown here in this example. A multiplicity symbol 606 is also provided to indicate that reference control frame 600 applies to multiple identical object features.

A datum is a user defined plane, axis, or point that individually or collectively with other datums comprises a datum reference frame. Datums are applied by the user on the engineering drawing or digital model using a flag, such as the flag 702 in FIG. 8, that identifies the datum as either datum X, Y, or Z or, alternatively, A, B, or C. A datum reference frame usually establishes a Cartesian coordinate system of which each datum represents one axis or plane of the coordinate system. Thus, for rigid bodied objects, up to three datum are used to constrain all six degrees of freedom. However, depending on the object and its features, no datum or only one or two datum may be specified. A datum reference frame establishes six degrees of freedom for a rigid body. Such degrees of freedom include three degrees of translation and three degrees of rotation and are represented by the surfaces of a, b, c, d, and e of the tiles 700 shown in FIG. 8 with respect to an X, Y, and Z datum. Each degree of freedom represents a potential source of variation for a feature, such as a surface. For example, during manufacturing, such as a machining process, the process's capacity to move in a degree of freedom can contribute to a variation or deviation of the feature's geometry from an ideal. In order to manufacture and verify an object, it may therefore be necessary to constrain those degrees of freedom so that measurements and manufacturing processes relative to the datum can be performed.

Such constraints are specified in terms of Form, Orientation, and Location. Form refers to a size or shape of a feature. Orientation refers to a rotation or angle of a feature. Location refers to a movement or position of a feature. The Orientation and Location of a feature and its geometric tolerance zone are defined relative to one or more datum. Form on the other hand can be defined relative to a datum but can also be defined relative to the feature itself and therefore does not require a datum to constrain the feature's shape or size. Thus, a feature and its geometric tolerance may be defined by its Form, Orientation, and Location in space relative to one or more datum thereby constraining the feature to that datum. These constraints are cumulative such that as each level of constraint increases, all lower levels of control remain in effect such that a single feature can be subject to many tolerance zones simultaneously. Each added level of constraint adds a level of control but also a level of complexity to the manufacturing process, as explained in more detail further below.

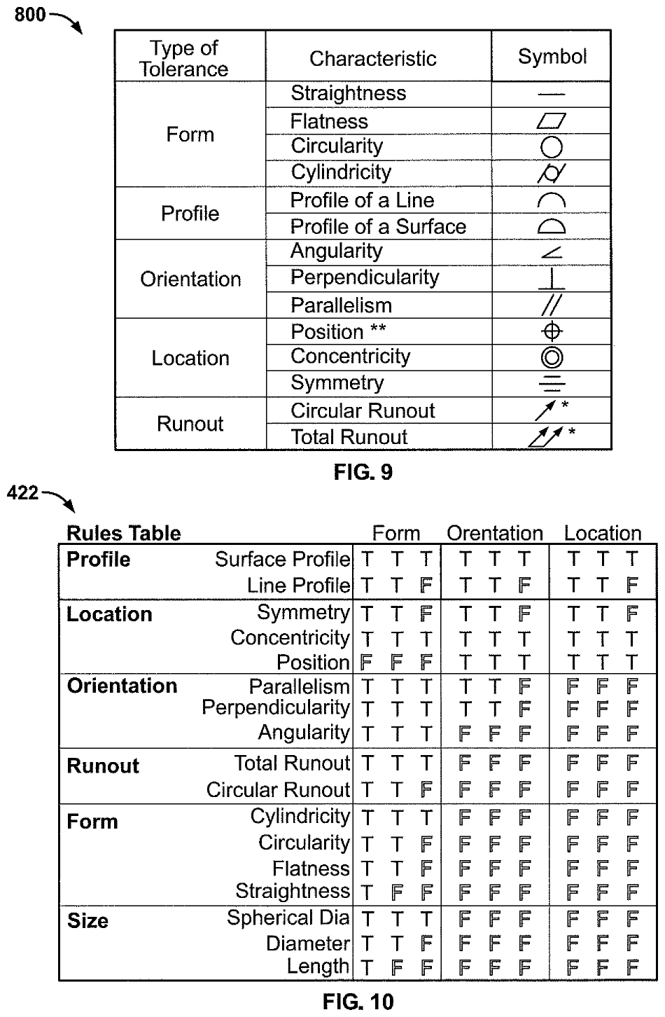

The application of Form, Orientation, and Location constraints is generally determined by the geometric character symbol. FIG. 9 depicts a table of symbols 800 with a description of their characteristics and type of tolerance. For example, a “flatness” symbol only relates to a feature's Form (i.e., its flatness). Thus, a geometric tolerance zone can be established with its boundaries parallel to the feature or parallel to a datum. In contrast, the character symbol of “Profile of a Surface” is generally applied to complex surfaces and constrains Form, Orientation and Location of its tolerance zone so that the boundaries of the tolerance zone follow the contours of the feature. Thus, unsurprisingly, more complex geometries generally require more constraints than less complex geometries. The Scoring and Ranking Plugin/Module 400/400′ tabulates the applicability of Form, Orientation, and Location to a character symbol using True and False statements in the Rules Table 422, as shown in FIG. 10. The application of Rules Table 422 is described further below.

The width or distance between tolerance zone boundaries is generally defined by the tolerance indicator 605 in reference control frame 600. Thus, the object feature including all its deviations must be located within the tolerance zone between its boundaries. As explained below, the tighter the tolerance zone becomes, the more difficult, costly, and challenging it is to manufacture the feature controlled by the tolerance zone. This difficulty is compounded with the application of each additional tolerance zone to the feature.

Some objects have several duplicate features which is termed “multitude” herein. For example, an object may have multiple holes arranged about a center axis of the object. In this case, the multitude indicates that the instructions of the feature control frame are repeated each time for each one of these features.

As shown in block 504, the Score and Ranking Plugin or Module 400/400′ operates in the background of the CAD Application 300/300′ and instructs the processor to determine a Sources of Variation Score (“SoV score”) for the geometric tolerance of the object feature of step 502. An SoV score quantifies the complexity added to the manufacturing process by each additional degree of constraint or source of variation control.

In manufacturing, features specified with higher levels of constraint require the manufacturing process to constrain the Form, Orientation, and Location of the geometric tolerance to more datums of the datum reference frame. Each constraint of Form, Orientation, and Location is an additional degree of constraint that is needed to control a source of variation in manufacturing. This increasing control to constrain sources of variation increases the complexity of manufacturing and therefore increases the SoV score by one point. Since the Form, Orientation, and Location of a geometric tolerance can be constrained to each datum, such constraints can contribute up to nine SoV points (i.e., three constraints per datum).

The SoV Score Routine 414 calculates the contribution of these constraints based on the user defined inputs and in accordance with the following: Such inputs include the feature control reference frame, datums, and dimensions of the feature and/or from the feature to the datums. Thus, when the user applies each of these inputs onto an object's design in the CAD application 400/400′, the SOV Score Routine operates automatically in the background.

In this regard, the routine first determines if the feature is one-dimensional, two-dimensional, or three-dimensional in accordance with the following:

$$[ Proportion ] = [ Feature Size ] \times [ \frac{1}{Max Feature Size} ] \geq Threshold Ratio$$

The “Proportion” matrix can be a 1×3, 2×3, or 3×3 matrix depending on the number of datum used. Proportion verifies whether the feature is functionally one-dimensional, two-dimensional, or three-dimensional. “Feature Size” may be either a maximum size of a geometric feature, the maximum size of a pattern of geometric features, the length of a geometric feature, or length of a pattern of features from its coordinate origin. In other words, the maximum feature size is the maximum length of the concatenation of the [Feature Size], [Pattern Size], and the [Length to Datum] matrices. A fourth column can be added in these matrices, when the maximum size or length is not aligned with the X, Y, and Z of the datum coordinate system. As shown, the feature size based on its dimensions in the X, Y, and Z coordinate system is populated in a “Feature Size” matrix and is multiplied with a matrix that is populated with values that are the inverse of the maximum feature size. The product of these two matrices is compared with a Threshold Ratio to determine if each value is greater than or equal to the Threshold Ratio. The Proportion matrix is populated with True or False statements depending on whether the value corresponding to its X, Y, or Z size is greater than or equal to the threshold ratio.

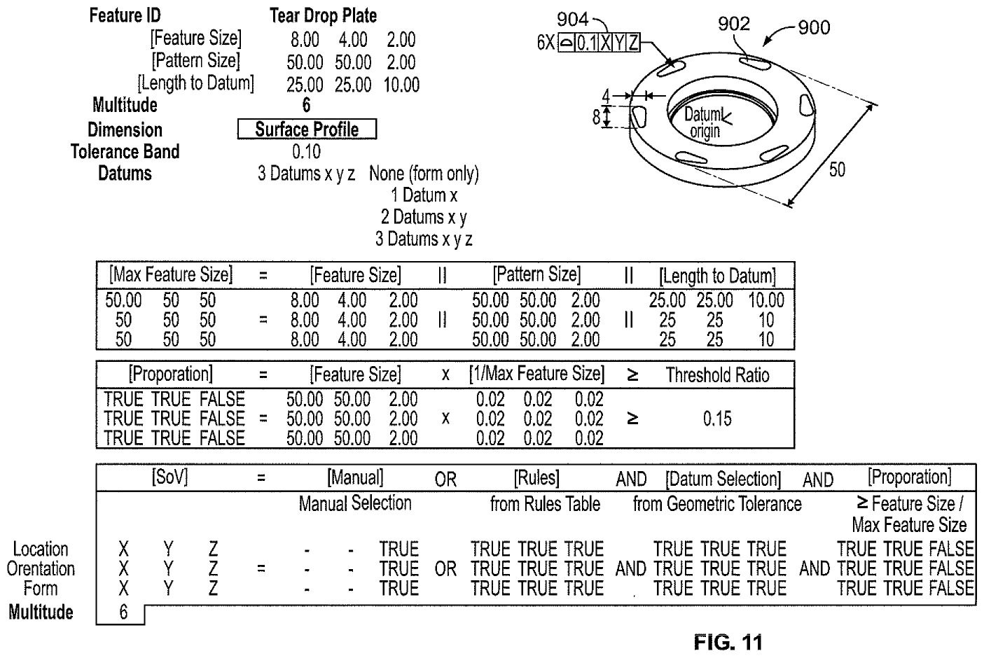

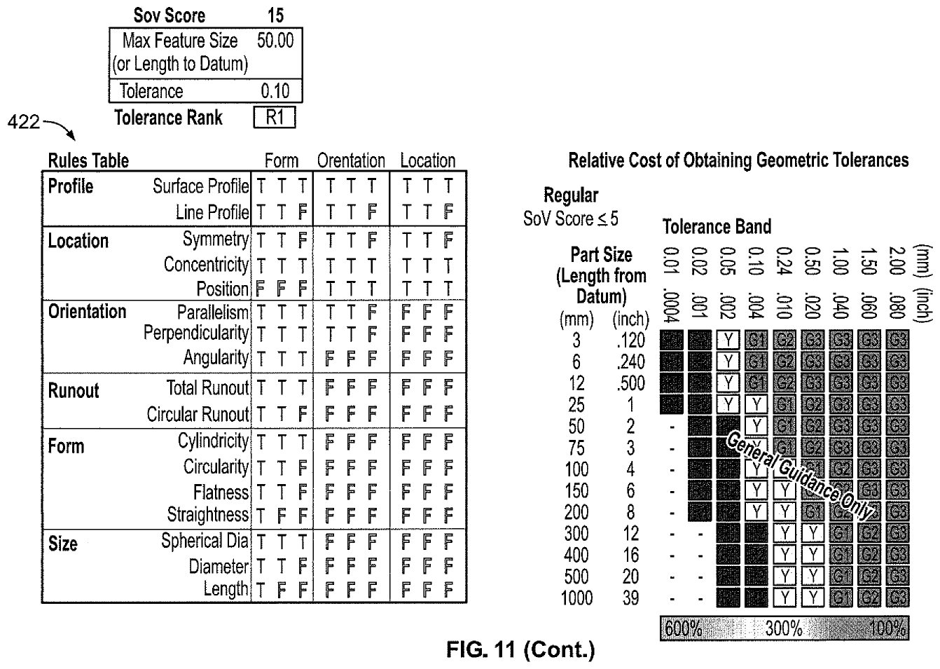

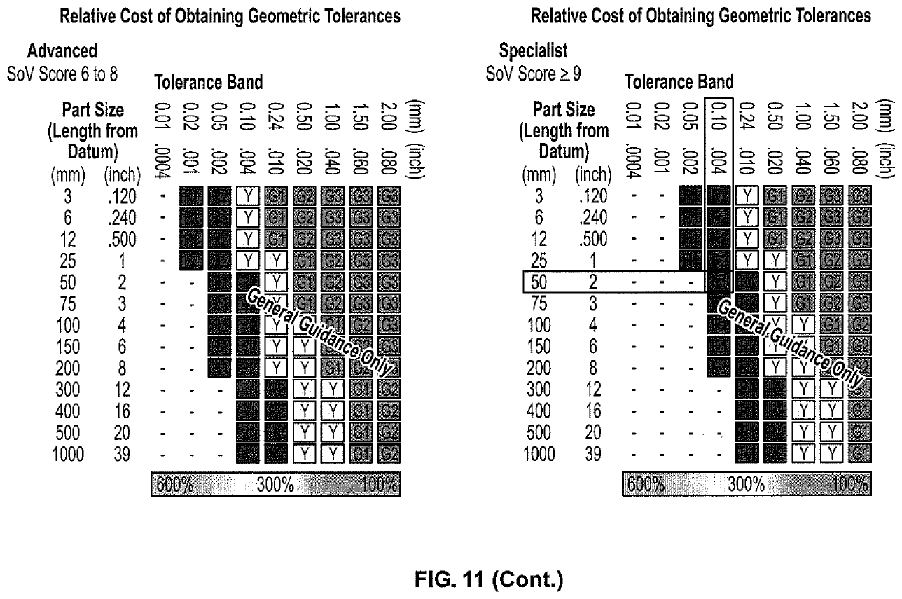

FIG. 11 provides an example in which a plate 900 includes six tear drop features 902. The feature control frame 904 indicates the “Profile of a Surface” symbol, a tolerance of 0.1, a multitude of 6, and datum X, Y, and Z. The [Feature Size] matrix relates to the dimensions of the geometric feature of a single tear drop which, in this example, is 8, 4, and 2 in the respective X, Y, and Z directions. The [Feature Size] matrix on the other hand relates to the pattern of tear drops such that the feature size in this example is accorded a basic dimension of 50 mm in the X and Y-directions and 2 mm in the Z-direction. Therefore, columns 1 and 2, which are respectively associated with the X and Y-dimensions, of the Feature Size matrix is populated with the value “50,” and column 3, which is associated with the Z-dimension, is populated with the value “2.” The inverse of the maximum feature size is 1/50 which is 0.02. The Threshold Ratio is established as 0.15. As shown in the Proportion matrix, which is based on the [Pattern Size] matrix, the size of the feature in both the X and Y coordinate space meet the proportionality test while the size of the teardrop features 902 in the Z-direction do not, which indicates that the pattern of the six tear drops 902 are proportionally two-dimensional. Thus, the first and second columns of the Proportion matrix associated with the X and Y-dimensions are True, and the third column associated with the Z-dimension is False.

The SoV score can then be calculated by the matrix logic equation:

$$[ SoV ] = [ Manual Selection ] OR [ Rules ] AND [ Datum Selection ] AND [ Proportion ]$$

Again, the size of the matrix is dependent on the number of datum just as the Proportion matrix above. The first row of the SoV matrix is associated with Location constraint, the second row is associated with Orientation constraint, and the third row is associated with Form constraint. The logic equation sets out to verify whether the specified feature in the CAD design is constrained with respect to Form, Orientation, and Location relative to the X, Y, and Z datums.

The Manual Selection matrix is populated based on the user's verification of the constraints. In this regard, the user can provide a manual override as necessary. The user may be prompted to verify the calculated assumptions regarding the dimensionality of the feature. The user's response to this prompt may be reflected in the Manual Selection matrix. In the example of FIG. 11, the Manual Selection matrix illustrates that the user overrode the Proportion matrix which determined that the Z-dimension of the of the tear drops 902 are proportionally two-dimensional. Thus, the Z-dimension is considered here for Form, Orientation, and Location constraints.

The Rules matrix is populated with reference to the GD&T Rules Table 422 and based on the character symbol identified by the user in the feature control frame. The Rules Table 422 is depicted in FIG. 10. As shown, the Rules Table 422 uses True and False statements with respect to the X, Y, and Z datums and Form, Orientation, and Location constraints. The True statements represent that Form, Orientation, or Location can be constrained to that datum for the associated character symbol. The False statement on the other hand means that such constraint does not apply for that symbol and therefore is not included in the SoV score.

The Datum Selection matrix verifies the number of datum selected using a True or False statement. The Proportion matrix is the same Proportion matrix defined above in the first part of the SoV Score Routine 414.

Continuing with the example of FIG. 11, the “Surface Profile” symbol was selected by the user and presented in the feature control frame 904. Thus, using the Rules Table 422, the Rules matrix is populated in every position with a True statement since the geometric tolerance for a surface profile can be constrained in Form, Orientation, and Position relative to every datum. Also, three datums (X, Y, and Z) were selected such that every position in the Datum matrix is populated with a True statement. Based on the previous Proportion matrix, the result would be an SoV contribution of six since the Proportion matrix zeroed out the Z-size of the teardrop features. However, the manual override of the Manual matrix negated this thereby requiring the SoV score to take Z-size into account. Therefore, the total contribution of Form, Orientation, and Location to the SoV score for this example is nine points which is tallied by counting each X, Y, and Z in the SoV matrix.

Other factors that increase an SoV score include multitude, assembly interfaces, and interdependence. As mentioned above, multitude is the total number of identical features to which the feature control frame is applied and is input by the user when applying the feature control frame. Thus, each object feature is given a score of one. In the example of FIG. 11, there are six teardrop features 904. Therefore, the SoV score is increased by 6 total points due to multitude which results in a final SoV score of 15.

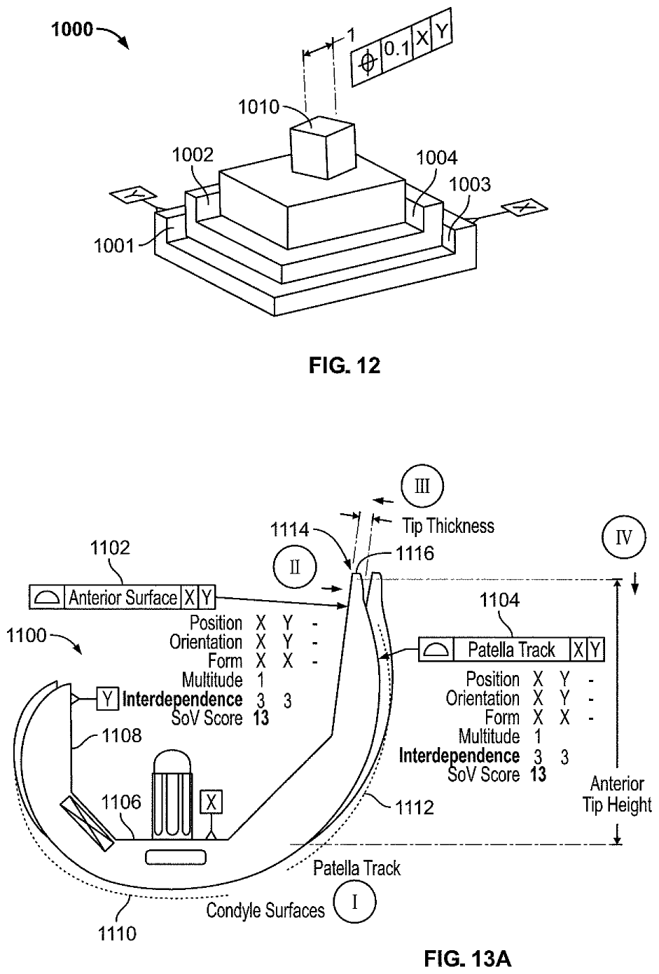

Not every object in a CAD design of CAD application 300/300′ stands alone, but instead may be included in an assembly with other objects. Complexity increases when datum are selected on another object of the assembly and one or more assembly interfaces are positioned between the datum reference and object feature. For example, in quality control, because a datum is selected on another object of the assembly, the inspector will not only have to ensure that the datum of the second object is fixed but also that the objects of the assembly are fixed relative to each other at their interfaces during the measurement and verification process. Thus, exemplary method 500, to account for the complexity added by datums applied across assembly interfaces, a score of one is added to the SoV score for each assembly interface between the datum reference and geometric tolerance. FIG. 12 provides an example in which an X-datum is selected across two interfaces 1003, 1004, and a Y-datum is selected across two assembly interfaces 1001, 1002 from the toleranced feature 1010 which increases the SoV score by four points. The SoV Score Routine 414 may automatically recognize assembly interfaces 1001-1004. Alternatively, a user may be prompted to select assembly interfaces 1001-1004 between the datum and object feature 1010.

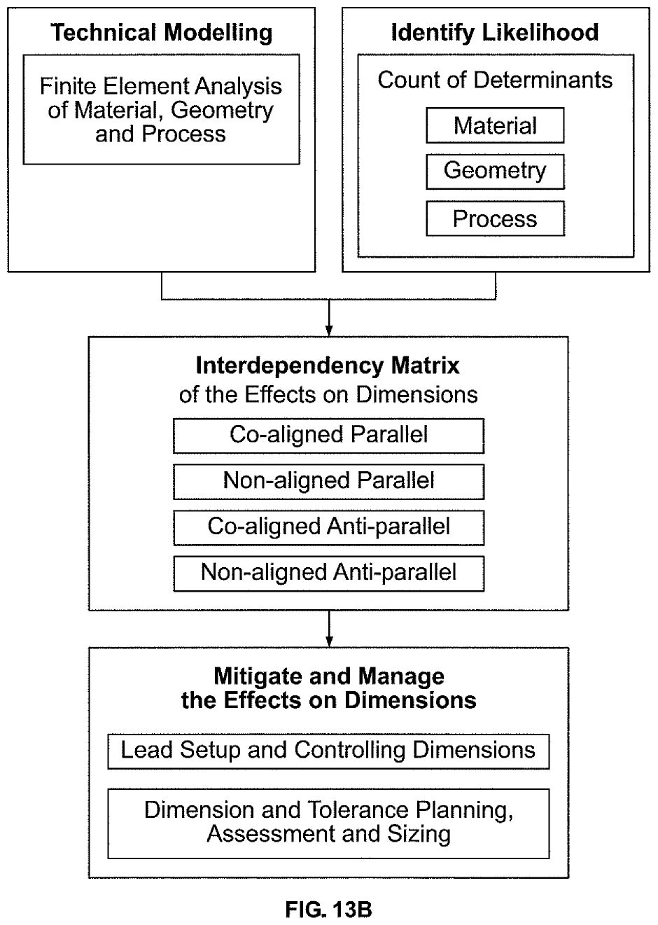

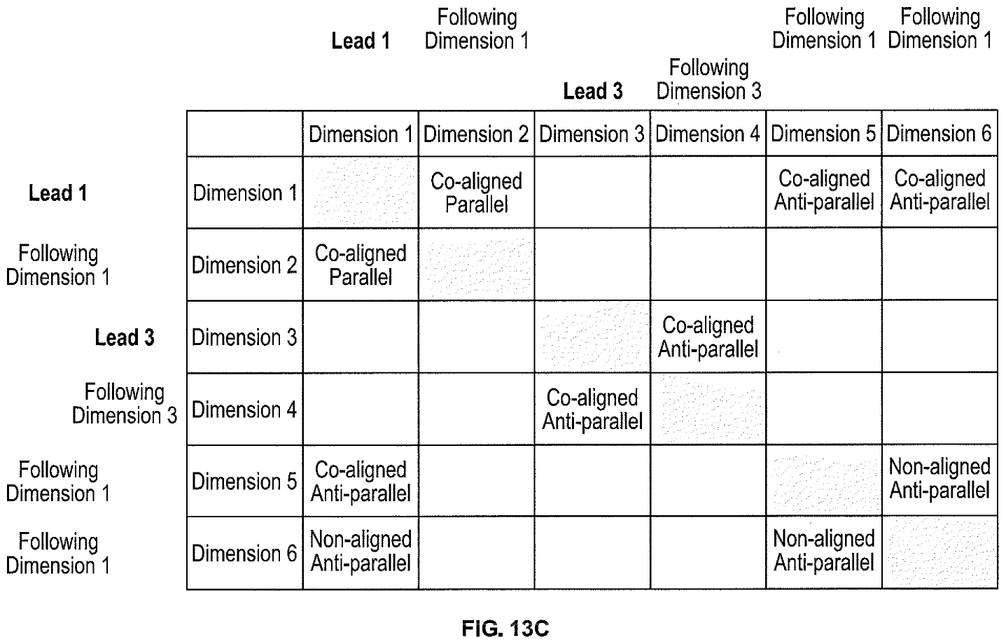

Interdependence generally applies to objects that are not a rigid body object such that during production of the object, the dimensional relationship between object features may change. In other words, object bodies that are not rigid increase the number of degrees of freedom that can affect the Form, Orientation, and Location of a feature. Thus, when in-process parameters controlling the production of features of an object are not independent, adjustment of one in-process parameter to adjust a feature requires a corresponding adjustment to other parameters to keep all object requirements within their specification. As one can imagine, interdependence increases production complexity. To account for this affect, the SoV score is increased by three for each datum axis that is affected by interdependence. FIG. 13A depicts an example of a femoral component 1100 of a total knee prosthesis. GD&T control reference frames 1102 and 1104 are respectively applied to an anterior surface and a patellar track surface of femoral component 1100. An X-datum is applied to a distal surface 1106, while a Y-datum is applied to a posterior surface 1108 of component 1100. Machining condyle surfaces 1110 and a patella track 1112 of component 1100 typically causes the femoral component 1100 to open. Thus, during the machining operation, the femoral component 1100 is not a rigid body object as there are additional degrees of freedom that affect the Form, Orientation, and Location of the femoral features. In this regard, the anterior surface opens out and increases its distance away from the Y-datum. Also, the tip thickness of an anterior flange 1114 decreases because the machining path cuts deeper as the anterior surface increases away from Y-datum which affects the patella track's relationship to Y-datum. The anterior tip 1116 height is also reduced thereby affecting both the anterior surface and patella track's relationship with X-datum. Thus, a total of six points is added to the SoV scores of the anterior surface geometric tolerance and patella track geometric tolerance due to interdependence. The SoV Score Routine 414 may prompt the user to input any know interdependencies.

FIG. 13B depicts a decision tree logic for assessing interdependence via scoring and ranking plugin/module 400/400′. In this regard, the existence of interdependence is evaluated, then the effects of the interdependency on dimensions is determined, and finally mitigation and management are assessed. Evaluation of the existence of interdependency, includes an evaluation of the materials, geometry, and in-process parameters (e.g., how much material is removed and whether the in-process temperature reaches the stress relaxation threshold) and their analysis using finite element analysis (“FEA”) under in-process conditions.

After this initial analysis is performed, an interdependency matrix is created. An exemplary matrix is shown in FIG. 13C for lead and following dimensions. Dimensions are co-aligned parallel where they increase or decrease together along parallel vector directions. Dimensions are non-aligned parallel when one increases and the other decreases along parallel vector directions. Dimensions are co-aligned anti-parallel when they increase together along vector axes that are not parallel. Dimensions are non-aligned anti-parallel when one increases and the other decreases along vector axes that are not parallel. At this point, interdependency can be used for the SoV score as the presence of interdependency and the number of axes it affects is determined.

Mitigation and management are elements of remediation which can help reduce the effects of interdependency. Here, the lead setup, controlling dimension, and following dimensions are identified. Larger tolerances are applied to the following dimensions, than the lead setup controlling dimension. Dimension and tolerance planning and assessing may include assessing process changes, standard deviations, and capabilities.

As described above, the SoV score is a mathematical sum by addition. However, the SoV score may also be the sum of other mathematical operations, such as a product sum, a weighted sum, or relative sum, for example. Also, the inclusion of multitude can be a multiplication rather than an addition, as discussed above. Thus, in the example of FIG. 11, the SoV score may be 54 (product of 9 constraints and 6 multitude). Relative cost array 424 in such embodiment for calculating the SoV score would be stratified accordingly.

As shown in blocks 506 and 508, the Score and Ranking Plugin or Module 400/400′ operates in the background of the CAD Application 300/300′ and instructs the processor to determine Tolerance Rank and Relative Cost for the geometric tolerance of the object feature of step 502.

The model of Tolerance Rank and Relative Cost can be calculated from the following linear equation:

$$Relative Cost or Tolerance Rank = a 0 + a 1 ( SoV ) + a 2 ( Tolerance ) + a 3 ( Feature Length ) + a 4 ( SoV ) ( Tolerance ) + a 5 ( SoV ) ( Feature Length ) + a 6 ( Tolerance ) ( Feature Length ) + a 7 ( SoV ) ( Tolerance ) ( Feature Length )$$

If enough business level information, such as actual costs of parts are available, the factor and interaction model could be written to generate a model of actual costs of feature dimensions and tolerances. The factors and interactions in such an equation may also have other mathematical operators, such as power factors to model quadratic influences. This model is for a three-factor model (i.e., three-dimensional model). However, a model with higher dimensions (i.e., more factors) could be implanted. Such higher dimensions can include interdependence, processing times, material type, or material costs.

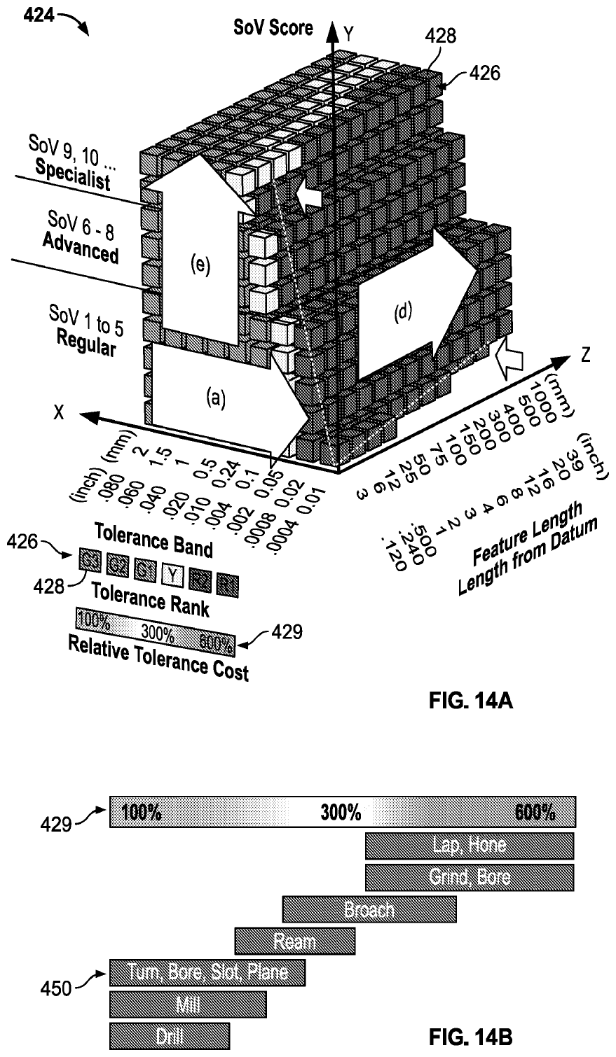

Once the SoV score for a particular feature or dimension is determined, the Tolerance Rank Routine 416 is activated which compares the SoV score to the Relative Cost 3-D Array 424. As shown in FIG. 14A, the Relative Cost 3-D Array 424 is comprised of a plurality of tolerance bands 426 which are each comprised of a plurality of tolerance ranks 428. The Relative Cost 3-D Array 424 is arranged in three dimensions relative to X, Y, Z axes of a Cartesian coordinate system and may be stored in a three-dimensional relational database of the computing device, for example. However, the array can be separated into in a plurality of two-dimensional arrays and stored in a two-dimensional relational database.

As shown, Y-axis corresponds to SoV score. The SoV scores are stratified into three groups which are Regular, Advanced, and Specialist. The Regular group includes the lower SoV scores, such as SoV scores of 1 to 5, and indicates that a lower level of skill and equipment is generally applicable and satisfactory. The Advanced group includes the mid-range SoV Scores, such as SoV Scores of 6 to 8, and indicates a high level of skill and/or equipment beyond that of the Regular group is generally warranted. Specialist group includes the highest range of SoV scores, such as SoV scores of 9 and above, and indicates the highest level of skill and/or equipment are required.

The X-axis of the Relative Cost 3-D Array 424 corresponds to tolerances and relative cost. Each tolerance band 426 is comprised of a plurality of tolerance ranks 428 which are each associated with a typical industry tolerance and categorized based on their relative cost and difficulty to manufacture. In this regard, each tolerance rank is given a color code and identifier which is related to its position in the tolerance band 426. In the embodiment depicted, each tolerance band 426 includes green, yellow, and red color codes. Each tolerance rank is given an identifier to identify to the user their location in the tolerance band 426 and the color category they belong to. For example, the green category or green zone ranks is identified as G₁, G₂, . . . , Gₙ, the yellow as Y₁, Y₂, . . . , Yₙ, and the red as R₁, R₂, . . . , Rₙ. If there is only one rank 428 of a color in a band 426, then no position number is included in the identifier, just the letter for the color and the color. The colors and identifiers allow the user to get a quick visual assessment of the difficulty and relative expense of the designated tolerance. In this regard, once the user inputs the GD&T reference frame on their drawing in the CAD application and the routines are run by the application, an alert window may be presented to the user showing the ranking of the tolerance. Green category or zone tolerance ranks 428 indicate that the relative cost is low while yellow category or zone tolerances ranks 428 indicate some caution and potential remediation but are of generally low concern. However, the red category or zone tolerances ranks 428 indicate the highest relative cost tolerances that are difficult and challenging to manufacture. Quickly identifying red category tolerances as the designer is designing the part opens the door to remediation early in the design process to avoid headaches down the road. As shown, the tolerance bands 426 decrease by one green tolerance rank 428 and moves over a step as the SoV Score crosses over into the next grouping. This is because a higher SoV score indicates more complexity which makes very small tolerances, such as 10 microns, unfeasible, impractical, or impossible.

In addition to tolerance bands 426, the X-axis also corresponds to relative cost bands or scales 429 which are stratified by relative cost and colors representing the same. The color scheme is correlated with color scheme of tolerance bands 426. Thus, in the illustrated example, green ranked tolerances have a relative cost of 100%, yellow 300%, and red 600%.

As shown in FIG. 14B, relative costs as well as the tolerance bands may be correlated with various manufacturing techniques/technologies (e.g., drilling, milling, reaming, broaching, grinding, boring, lapping, honing, additive manufacturing, casting, injection molding (plastic or metal), planning, boring, slotting, etc.) via manufacturing technology bands 450, which may be based on industry guidance, such as ANSI/ASME B4.1-1967, for example. Such manufacturing technology bands 450 are correlated to a relative cost and one or more tolerance ranks 428 to the extent that the manufacturing technology associated with band 450 can be effectively used for a part feature of the determined complexity. Thus, the user may be automatically prompted or otherwise informed as to the applicable production technology for the manufacture of an object along with their relative costs. This allows the comparative assessment of manufacturing technologies early in the design phase. Remediation to target more economical or practical manufacturing technology is also made simpler by the method described herein as targeted adjustments and reassessments can be made.

Similarly to manufacturing technology bands 450, manufacturing source bands 460 may be used to assess sourcing decisions. In this regard, parts, assemblies and products of manufacturing sources are scored and ranked to identify the complexity and relative cost of the parts, assemblies and products supplied. In this assessment, actual costs can be added to each block or cell of bands 460 to enable assessment of relative versus actual differences for the different manufacturing sources.

The Z-axis corresponds to feature length or length from datum. Similar to the relationship between tolerances and SoV Score, the greater the feature length or the length from its datum, the wider the tolerance bands 426 become indicating the level of difficulty of achieving tight tolerances becomes greater with increasing feature size. Thus, the Tolerance Rank Routine 416 uses SoV score, tolerance as defined in the user defined reference control frame, and part size (or length of feature from datum) to triangulate to the appropriate tolerance rank 428. The Relative Cost Routine then associates the tolerance rank with a relative cost. Relative cost can be determined by the number of the position of the identified tolerance rank 428 within the tolerance band 426 starting first with the green category tolerance ranks. For example, where a tolerance rank 428 is at position number five within a tolerance band, its relative cost is 500% as it is relative to the four other adjacent tolerance ranks.

As shown by the arrows a, d, and e, tighter tolerances are more expensive to manufacture, the cost of tight tolerances increases with larger objects, and tight tolerances with more sources of variation to be constrained cost more.

As shown in block 504, if the Relative Cost and/or Tolerance Rank are in the red zone, then the user is alerted to pursue remediation. If in the yellow or green zones, then the user may continue with applying a geometric tolerance to another object feature.

Continuing with the example of FIG. 11. the tolerance is specified as 0.10 mm, the max feature size is 50 mm, and the SoV score is 15. An SoV score of 15 falls within the specialist grouping. The tolerance rank based on this tolerance band and part size is an R₁, which is the most difficult and expensive tolerance for this tolerance band. Its relative cost is about 600%. The user in this example would be alerted to engage in remedial action.

As shown in blocks 514, 516, 518, 520, and 522, the object level routines may proceed in parallel to the feature level routines of blocks 504, 506, 508, 510, and 512. In this regard, once the SoV score, tolerance rank, and relative cost are determined for a particular object feature, this data is aggregated and stored in a database, such as a relational database, for further use, as shown in block 514. As the user continues to tolerance additional object features, the object level routines 411 continue to compile the complexity and relative cost data for each of those features.

Each feature that is given an SoV score and tolerance rank can be grouped together for a high-level analysis of the object. For example, each feature may be provided a designation (e.g., Dim 1 or F₁) and saved in a database with its SoV Score, tolerance rank, relative cost, and absolute position number in its tolerance band moving in a direction from green to red. The relative cost is associated with this position. For example, a relative cost of 300% is associated with a tolerance rank in the third position. This is done for each feature or dimension for an object that is given a geometric tolerance. If the user so chooses, they may obtain a report or be prompted in a pop-up window at any time during the design providing a contextual analysis of the object up to that point in the design at which time, the Total Sum Relative Cost Routine 413 and Total Sum Complexity Routines 415 respectively sum the tolerance rank positions values and SoV scores for all the object's features. The user may also be automatically provided a report or pop-up window at any designated end point to the design process, such as converting a three-dimensional model to print as a two-dimensional engineering drawing. The Total Relative Cost and Total Sum Complexity Routines 413, 415 may also produce various charts, such as bar charts and dot plots, for example, to provide further context which can help the user further identify avenues and tolerances for potential remediation.

As shown in block 522, if any tolerances of concern are identified, they may be remediated. For example, the individual user or design group may revisit a red category tolerance that the user had been previously alerted to for remediation. However, the report may also provide context for identifying other tolerances for remediation, such as those in the yellow zone or that appear to be an outlier with respect to other tolerances of the object, for example. If no tolerances of concern are identified, the design may proceed to finalization.

As shown in block 524, the tolerances of concern may be remediated. Remediation may include any number of solutions such as confirming the tight tolerances with the manufacturer and/or a specialist and/or an initial batch of the object may be manufactured to obtain early estimates of the process standard deviations for any tolerance with an R1 or R2 tolerance rank. Remediation may also include the designer or design group redesigning the feature or tolerance and then verifying a shift in tolerance rank to a desired level by repeating method 500 with the redesigned feature.

In this regard, an optional machine learning and artificial intelligence component 460 of plugin 400/module 400′ can be used to help determine what adjustments may be made for a desired remediation output. For example, where it is desirable to lower the relative cost, component 460 can be calibrated in user settings of plugin 400/module 400′ remediate to the highest tolerance rank 428 of the next lowest relative cost or perhaps to a specific manufacturing source (e.g., reaming). Component 460 may then run simulations adjusting the different variables discussed above to land within the desired relative score, discard adjustments that do not fit predefined criteria, and provide a list of possible adjustments that could be made. The list can be ranked in order based on the likelihood of acceptance as determined by previously accepted remediations of a similar nature.

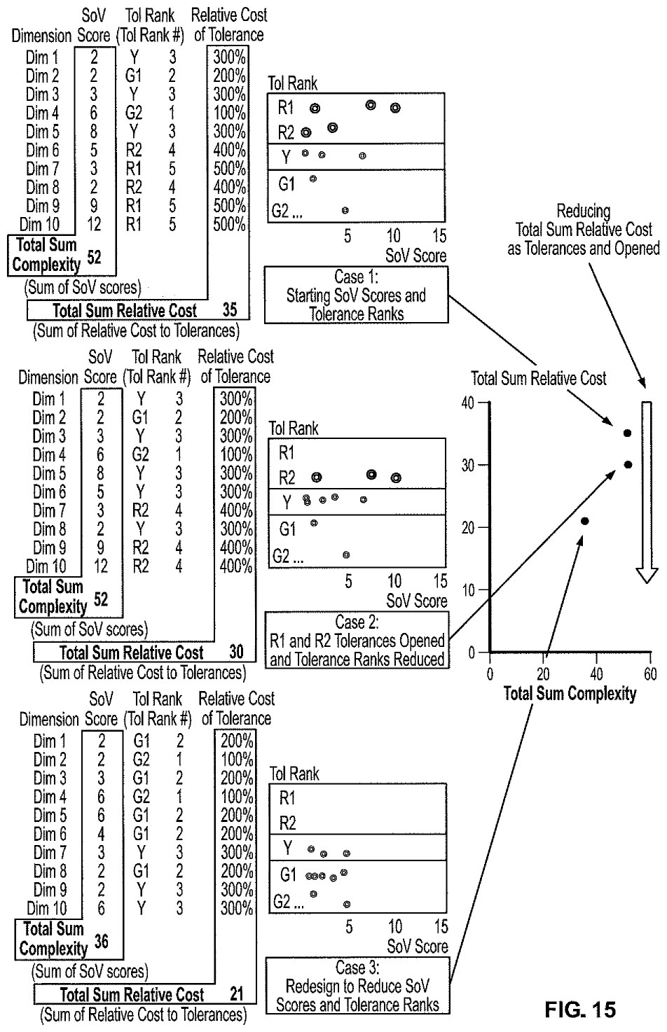

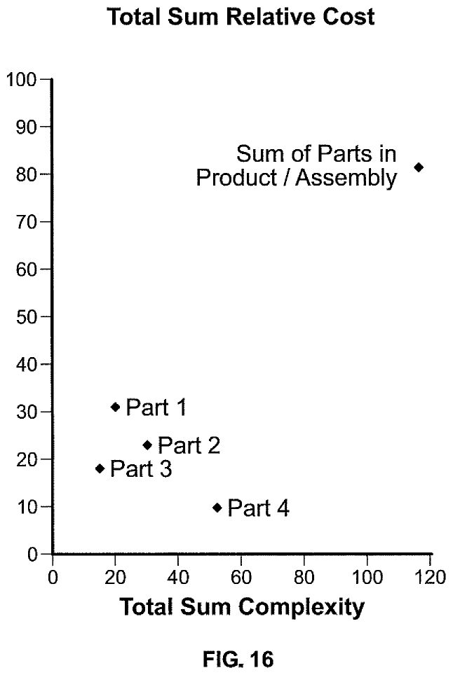

The scores and ranks provided by method 500 may further assist the user in identifying avenues for remediation. FIG. 15 provides exemplary remedial cases for a design with 10 dimensions or toleranced features. As shown, in Case 1, the total sum complexity is 52 and the total sum relative cost is 35. Each dimension is plotted in a scatter plot with tolerance rank as the Y-axis and SoV score as the X-axis. As shown in Case 2, which is a remediation of Case 1, the tolerance ranks are shifted down by opening the tolerances, and, in Case 3, which is another remediation case, the object was redesigned so that the SoV scores are reduced and shifted left in the dot-plot. The result between Case 1 and Case 3 is a reduction of relative cost by about 40% and the complexity by about 30%. Also, a total sum complexity and relative cost for an entire product/assembly made up of multiple objects/parts can be determined based on a sum of the total sum relative costs and complexities of each of its component parts. The total sum relative costs and complexities for each part and for the entire assembly can be plotted together as shown in FIG. 16 for further visual context and evaluation.

While the Scoring and Ranking plugin or module 400/400′ has been described herein as being functional to output SoV scores, tolerance ranks, and relative costs, other embodiments of system 100 are contemplated in which an SoV scoring plugin or module is provided in lieu of Scoring and Ranking plugin or module 400/400′. In this regard, such SoV scoring plugin or module may be configured to only determine the SoV score and to provide that score to the user, such as in the manner described above. This would allow the user to obtain an initial general assessment of the manufacturing difficulty of a particular object feature and make note for further consideration and potential remediation.

Additionally, in some embodiments, an SoV score may be applied to an object feature based on less complicated dimensions (e.g., linear lengths, radii, diameters and spherical diameters) and tolerances that define the feature of size in one, two, and three coordinate (X, Y, Z) dimensions, rather than geometric dimensions and tolerances which are of a greater complexity. As such, the SoV score would not be based on the GD&T standards and its standardized constraints of Form, Orientation, and Location, as described above, but may instead, for example, take into account the number of linear dimensions that are applied to a particular feature in a Cartesian coordinate system within in a CAD application. For example, a through-hole in an object may be provided with a linear diameter to specify the diameter of the through-hole itself and linear dimensions relative to other object features, such as planar surfaces, to specify the through-hole's location relative to those object features. Thus, the more object features the through-hole is related to through linear length dimensions, the more constrained the through-hole is thereby warranting a higher SoV score, which may be a sum or multiplication of the number of constraints and the object features multiplicity. In this regard, this alternative SoV Scoring and Ranking plugin or module may be configured to count the number of dimensions applied to a particular feature or features in the background of the CAD application in real time as the user is applying those dimensions to thereby determine the number of constraints. Furthermore, the dimensions themselves, such as linear lengths, and the tolerances applied to such dimensions may be used in a similar manner described herein to correlate SoV scores, tolerance ranks, and relative costs which may be done via a relative cost array as a component of the plugin/module similar to relative cost array 424. For these less complicated dimensions, the matrix construction in FIG. 11 counts from and size in the one matrix row. However, the matrix construction may include a fourth row in which form and size would be recorded and counted in separate rows.

In some embodiments of plugin 400/module 400′, a machine learning and artificial intelligence component 460 can be optionally included and may aid in the scoring and ranking of dimensions and tolerances. In this regard, the machine learning and artificial intelligence component can help determine the complexity of a dimension and/or identify tolerance stack up chain complexity. Chain dimensioning is generally a situation in which a second feature is dimensioned relative to a first feature, a third feature is dimensioned relative to the second feature, and so on. The tolerances of each of these dimensions are stacked so that features at one end of the end of the chain have large tolerances relative to the features at the other end of the chain. This can result in either an object that requires tight tolerances between each feature to ensure the object's features remain functional, or an object that is non-functional and must be scrapped. Component 460 can identify stack up chains and its total complexity based on the previously determined complexity of each dimension in the chain.

In a further embodiment of plugin 400/module 400′, a Tolerance Application Routine 417 can be optionally included in the feature level routines 412 and may function to apply or select a tolerance for a particular dimension/feature. In this regard, plugin 400/module 400′ may have a user accessed menu or may provide an automatic pop-up window to the user which allows a user to select a desired tolerance rank 428 to a dimension/feature. In one example, plugin 400/module 400′ may then run multiple simulations in the background of the CAD application 300/300′ based on the known variables, a processor selected tolerance, and the method described above until the desired tolerance rank 428 is achieved. Once that tolerance rank 428 is achieved, plugin 400/module 400′ either automatically populates the object model in CAD application 300/300′ with the tolerance or presents the tolerance to the user in a pop-up window for the user's evaluation. In another example, plugin 400/module 400′ may continue the simulation even after a tolerance satisfying the tolerance rank condition is achieved in order to identify the totality of tolerances that can achieve the desired tolerance rank 428. Plugin 400/module 400′ may prompt the user to select the desired tolerance or may be provided pre-instructions via user settings to automatically select either the lowest or highest relative cost tolerance that achieves the desired tolerance rank 428 and populate the object model in CAD application 300/300′ with the same.

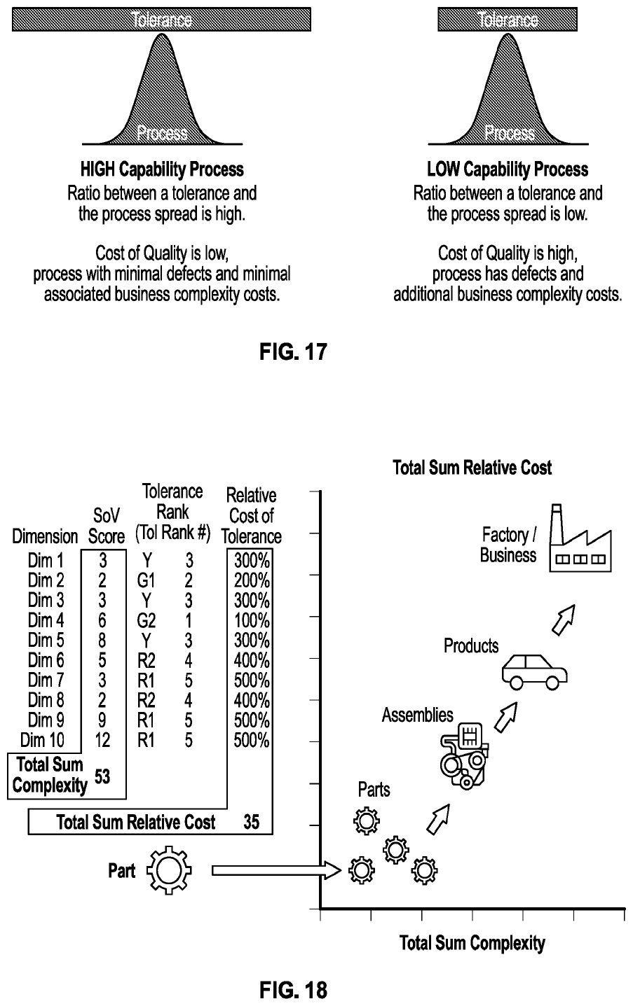

Additional embodiments of plugin 400/module 400′, complexities of parts can be aggregated into assemblies, products, and factory/business. Tolerances are a source of and driver of complexity within a product and a business. As tolerances become tighter approaching lower values and the limit of zero tolerance, they end up requiring more expensive processes, controls, and inspections in order for such tolerances to be manufactured. In addition to the increased expense, there is typically a reduction in the capability ratio of the size of a tolerance relative to the process, as illustrated in FIG. 17. When the quality capability of a process is high, the cost of quality is low because defects, non-conformances and the associated business complexity costs are minimal. On the other hand, when the quality capability of a process is low, the cost of quality is high because the process manufactures defects, generates non-conformances, and generates additional business complexity costs.

By summing SoV scores and tolerance ranks 428 of the features of a part, and then summing the parts into assemblies, and then assemblies into products, the complexity and relative costs of the parts, assemblies, and products within a factory or business can be plotted on a “Total Sum Complexity and Relative Cost” chart, as shown in FIG. 18. Thus, as each part is designed, plugin 400/module 400′ may operate in the background to continuously populate this chart so that the user can obtain real-time analysis of the complexities and relative costs of various parts, assemblies, products, and the like.

To see this increasing complexity against business metrics, the SoV scores, tolerance ranks 428, and relative costs can be mapped through a complexity algorithm with other quality business metrics to create “measures of increasing complexity.” For example, the SoV score, tolerance rank, relative cost of tolerances, and a process capability measure are used by processor 112 to generate a “measure of complexity.”

$$Measure of Complexity = ( SoV ) ( Tol Rank ) ( \frac{Target Process Capabilities}{Actual Process Capabilities} )$$

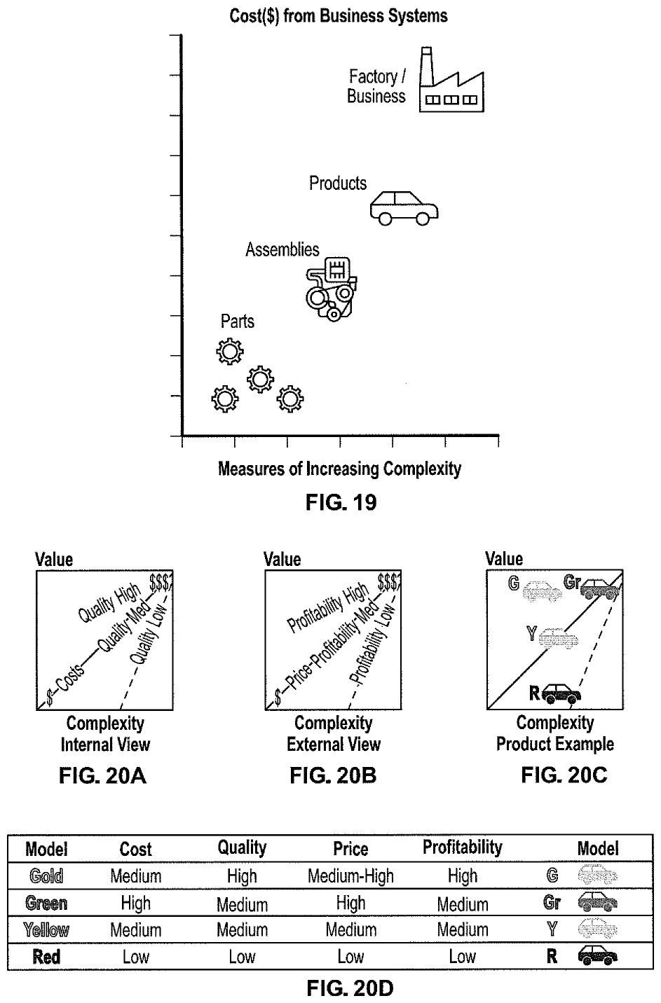

The “measure of complexity” can then be used by processor 112 to create a map of complexity within a business. For example, in FIG. 19, the accumulation of “measures of complexity and costs” within a factory or business may be charted. Where actual costs for example parts, maybe read from business systems, for example cost accounting or financial control systems.

In the assessment of parts to a product, the accumulating complexity can influence the value of a product or the value of a business in many ways. To those internal to a business, the value of a part is its cost to manufacture along with associated business complexity costs such as quality level. To those external to a business, the value to a customer is the price of a product, and the value to a business of a customer buying a product is profit.

For example, in FIG. 20A. an internal view of “value” and “complexity” is shown as “costs” and “quality,” and an external view of “value” and “complexity” is shown in FIG. 20B as “price” and “profitability.” Also, shown in FIGS. 20C and 20D is a product example, for four product models: gold, green, yellow, and red models. The gold model has medium costs and high quality, which allows it to sell for a medium to high price, that generates a higher level of profitability. The green model has more features, higher costs, and medium quality and although it sells for a high price, its profitability is medium. The yellow model has medium costs and quality and sells for a medium price to generate a medium level of profitability. The red model is a low cost and low-quality product and sells for a low price and generates a low level of profitability. In these value and complexity charts shown in FIGS. 20A-20C, the first plotted axis (i.e., the abscissa), is along a diagonal, and the second plotted axis (i.e., the ordinate), is a rotation around the upper right-hand corner. The origin and the upper diagonal limit can be selected to aid the visualization needs of the chart. Instead of “quality” and “profitability,” the influence of complexity on a business may also be assessed with other measures such as “lead-times”, “field servicing costs,” “recall costs,” “customer complaints,” and the like.

Using this framework, the influence of business complexity can be assessed for the products of a business and the accumulation and influence of complexity can be mapped by processor 112 through the business from tolerances of parts to assemblies to final products.

Although the invention herein has been described with reference to embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A computer-implemented method of scoring and ranking a geometric tolerance applied to an object feature having one or more dimensions in a Computer Aided Design (“CAD”) application by a user in accordance with Geometric Dimensioning and Tolerancing (“GD&T”) standard, the geometric tolerance having one or more of Form, Orientation, and Location constraints and a tolerance range, the method comprising:
determining, by one or more processors executing a CAD application, a sources of variation (SoV) score based on a total number of Form, Orientation, and Location constraints of the geometric tolerance, wherein the SoV score is calculated in the background of the CAD application;
determining, the one or more processors, a tolerance rank based on the SoV score, the tolerance range, and one of the one or more dimensions of the object feature via a database correlating the SoV score, tolerance range, and the one of the one or more dimensions, the tolerance rank having an identifier that indicates its position in a tolerance band relative to other tolerance ranks in the tolerance band; and
automatically generating a notification for presentation to the user of the tolerance rank.

2. The method of claim 1, wherein determining the SoV score includes determining whether the object feature is one-dimensional, two-dimensional, or three-dimensional.

3. The method of claim 2, further comprising automatically generating a prompt requesting the user to verify the determination of whether the object feature is one-dimensional, two-dimensional, or three-dimensional.

4. The method of claim 1, wherein the geometric tolerance includes one or more datum and determining the SoV score includes correlating the Form, Orientation, and Location constraints to the one or more datum and counting the number of instances of Form, Orientation, and Location for each of the one or more datum.

5. The method of claim 4, wherein the geometric tolerance includes a geometric character symbol and correlating the Form, Orientation, and Location constraints to the one or more datum is performed by reference to a GD&T Rules table that correlates the geometric characteristic symbol with the number of Form, Orientation, and Location constraints and a given datum.

6. The method of claim 4, wherein determining the SoV score includes determining whether the one or more feature or datum is affected by interdependence.

7. The method of claim 6, wherein, when a datum is affected by interdependence, assign a lead and following dimensions, and applying larger tolerances to the following dimension than the lead dimensions.

8. The method of claim 1, wherein the geometric tolerance includes a multitude which is the total number of object features to which the geometric tolerance has been applied, and determining the SoV score includes summing the multitude with the total number of Form, Orientation, and Location constraints.

9. The method of claim 1, further comprising determining a relative cost of the geometric tolerance based on the tolerance rank.

10. The method of claim 9, wherein the automatically notifying step includes notifying the user of the relative cost.

11. The method of claim 1, wherein the determining steps and alerting steps are performed by a Scoring and Ranking plugin in communication with the CAD application.

12. The method of claim 11, wherein the determining and alerting steps are performed automatically by the Scoring and Ranking plugin once the geometric tolerance is applied to the object feature.

13. The method of claim 1, wherein the automatically notifying step is performed when the tolerance rank falls within a category of concern.

14. The method of claim 12, if the tolerance rank falls within a category of concern, further comprising:
at least one of decreasing the total number of Form, Orientation, and Location constraints and expanding the tolerance range, and
repeating the determining steps.

15. A computer implemented method of designing an object in a Computer Aided Design (“CAD”) application using Geometric Dimensioning and Tolerancing (GD&T), comprising:
drawing, by one or more processors, an object in the CAD application, the object having a plurality of features;
applying, by one or more processors, a geometric tolerance to at least one of the features, the geometric tolerance having one or more of Form, Orientation, and Location constraints and a tolerance range according to a GD&T standard;
determining, by the one or more processors, a relative cost of the geometric tolerance using the tolerance range and a total number of the one or more constraints of Form, Orientation, and Location, wherein the relative cost is calculated in the background of the CAD application; and
automatically generating a notification to the user of a relative cost of the geometric tolerance relative to narrower and/or broader tolerance ranges than the tolerance range selected for the one or more features of the object.

16. A non-transitory computer-readable medium having instructions stored thereon which, when executed by a processor, cause the processor to perform a method of scoring and ranking a geometric tolerance applied to an object feature having one or more dimensions in a Computer Aided Design (“CAD”) application by a user in accordance with Geometric Dimensioning and Tolerancing (“GD&T”) standard, the geometric tolerance having one or more of Form, Orientation, and Location constraints and a tolerance range, the method comprising:
determining, by one or more processors executing a CAD application, a sources of variation (SoV) score based on a total number of Form, Orientation, and Location constraints of the geometric tolerance, wherein the SoV is calculated in the background of the CAD application;
determining, by the one or more processors, a tolerance rank based on the SoV score, the tolerance range, and one of the one or more dimensions of the object feature via a database correlating the SoV score and tolerance range, the tolerance rank having an identifier that indicates its position in a tolerance band relative to other tolerance ranks in the tolerance band; and
automatically generating a notification for presentation to the user of the tolerance rank.

17. The non-transitory computer-readable medium of claim 15, wherein determining the SoV score includes determining whether the object feature is one-dimensional, two-dimensional, or three-dimensional.

18. The non-transitory computer-readable medium of claim 17, further comprising automatically generating a prompt requesting the user to verify the determination of whether the object feature is one-dimensional, two-dimensional, or three-dimensional.

19. The non-transitory computer-readable medium of claim 13, wherein the geometric tolerance includes one or more datum and determining the SoV score includes correlating the Form, Orientation, and Location constraints to the one or more datum and counting the number of instances of Form, Orientation, and Location for each of the one or more datum.

20. The non-transitory computer-readable medium of claim 18, wherein the geometric tolerance includes a geometric character symbol and correlating the Form, Orientation, and Location constraints to the one or more datum is performed by reference to a GD&T Rules table that correlates the geometric characteristic symbol with the number of Form, Orientation, and Location constraints and a given datum.
